(19) United States
(12) Patent Application Publication
(10) Pub. No.: US 2026/0024467 A1
(43) Pub. Date: Jan. 22, 2026

(54) REDUCTION TASK TRAINER AND METHODS OF MANUFACTURE

(71) Applicant: THE CHILDREN’S MERCY HOSPITAL, Kansas City, MO (US)

(72) Inventors: Brian HARVEY, Weatherby Lake, MO (US); Nicole FILLINGAME, Independence, MO (US); Robert D. SCHREMMER, Kansas City, MO (US); Aiden MCLUCKIE, Mission, KS (US)

(21) Appl. No.: 19/264,226

(22) Filed: Jul. 9, 2025

Related U.S. Application Data
(60) Provisional application No. 63/671,971, filed on Jul. 16, 2024.

(51) Int. Cl. G09B 23/32

(52) U.S. Cl. CPC G09B 23/32

(57) ABSTRACT

A finger joint reduction simulation training device includes forearm, carpal, metacarpal, proximal phalanx, and middle phalanx portions, and at least one biasing element. The carpal portion is attached to a distal end of the forearm portion. The metacarpal portion is connected to the carpal attachment. The proximal phalanx portion has a proximal end that is connected to the metacarpal portion and a distal end opposite to the proximal end. The distal end includes a dislocation guide surface with a depression formed therein. The middle phalanx portion is positioned adjacent the proximal phalanx portion and includes a proximal end with a terminal surface configured to shift relative to the dislocation guide surface and includes a projection configured to extend into the depression of the dislocation guide surface. The biasing element is configured to bias the terminal surface of the middle phalanx portion against the dislocation guide surface.

### CROSS REFERENCE TO RELATED APPLICATION

The present application claims the priority benefit of U.S. Provisional Patent Application Ser. No. 63/671,971, filed Jul. 16, 2024, entitled REDUCTION TASK TRAINER AND METHODS OF MANUFACTURE, incorporated by reference in its entirely herein.

### FIELD

The present application claims the priority benefit of U.S. Provisional Patent Application Ser. No. 63/671,971, filed Jul. 16, 2024, entitled REDUCTION TASK TRAINER AND METHODS OF MANUFACTURE, incorporated by reference in its entirely herein. The present invention relates to anatomical models for medical simulation training devices, and in particular, simulating reduction of human joints. Embodiments concern models for simulating joint reductions by using moving internal parts and an outer layer that that mimic natural movement and movements and sounds in the event of dislocation and reduction.

### BACKGROUND

Medical professionals, including physicians, nurses, certified athletic trainers, etc., must possess the education, training, and expertise to perform dislocation reductions, or the repositioning of dislocated appendages back into proper position and orientation within their respective joints. For example, reductions are a regular part of the care certified athletic trainers provide, especially when it comes to services provided to school districts for school sporting events. Certified athletic trainers are expected to perform at the highest of their ability, including for high stress dislocation reductions, as appropriate.

Current training for dislocation reductions involve showing reduction techniques on another person, but it does not involve the trainee performing the reduction as part of the competency training. To obtain a first-person perspective encompassing the visual, tactile, and auditory aspects of executing a reduction, a trainee is required to conduct the procedure on a patient. However, it can be risky to allow a novice trainee to perform reductions on patients. Thus, there is a need for improved training that accurately simulates reductions in a risk-free environment to thereby lower risk in real-world procedures.

This background discussion is intended to provide information related to the present invention which is not necessarily prior art.

### SUMMARY

Embodiments address the above-described and other limitations in the prior art by providing a finger joint reduction simulation training device and a method of forming the same for training users on reductions methods by using synthetic bone structures having surfaces configured to accurately approximate the haptic and sonic feedback of a joint reduction.

In one or more embodiments, a finger joint reduction simulation training device includes a forearm portion, a carpal attachment, a metacarpal portion, a proximal phalanx portion, a middle phalanx portion, and one or more biasing element. The forearm portion has a distal end, and the carpal attachment is connected to the distal end of the forearm portion. The metacarpal portion is connected to the carpal attachment. The proximal phalanx portion includes a proximal end connected to the metacarpal portion and a distal end opposite the proximal end and having a dislocation guide surface with a depression formed therein. The middle phalanx portion is positioned adjacent the proximal phalanx portion and includes a proximal end with a terminal surface configured to shift relative to the dislocation guide surface. The terminal surface includes a projection configured to extend into the depression of the dislocation guide surface. The one or more biasing element is configured to bias the terminal surface of the middle phalanx portion against the dislocation guide surface.

In one or more embodiments, a finger joint reduction simulation training device includes a forearm housing, a handle, a lid, a carpal attachment, one or more metacarpal portions, one or more proximal phalanx portions, one or more middle phalanx portions, one or more biasing element, and one or more flexible connector loop. The forearm housing defines an inner cavity with an inner surface and includes a proximal end, a distal end, and an access opening. The proximal end has a proximal opening, the distal end has a distal opening, and the access opening is located between the proximal end and the distal end and is in communication with the inner cavity. The forearm housing also includes one or more projections extending radially inward from the inner surface of the inner cavity. The handle is attached to the proximal end of the forearm housing. The lid is removably secured to the access opening. The carpal attachment is connected to the distal end of the forearm housing and has one or more axially extending passages that are in fluid communication with the inner cavity of the forearm housing. The one or more metacarpal portion is pivotally connected to the carpal attachment and has an axially extending metacarpal channel that is at least partially aligned with the one or more axially extending passages of the carpal attachment.

The one or more proximal phalanx portion is pivotally connected to the one or more metacarpal portion and includes a proximal end and a distal end and defines a phalangeal cavity and two laterally extending proximal cavities. The proximal end is adjacent to the one or more metacarpal portion. The distal end is opposite the proximal end and includes a dislocation guide surface with a depression formed therein. The phalangeal cavity extends axially into the proximal end of the one or more proximal phalanx portion and at least partially aligns with the axially extending metacarpal channel. The two laterally extending proximal cavities are located between the distal and proximal ends of the one or more proximal phalanx portion and are in fluid communication with the phalangeal cavity.

The one or more middle phalanx portion is positioned adjacent the one or more proximal phalanx portion and includes a proximal end and defines a through hole formed in the proximal end. The proximal end includes a terminal surface configured to shift relative to the dislocation guide surface and has a projection configured to extend into the depression of the dislocation guide surface.

The one or more biasing element is positioned in the forearm housing and has a proximal end connected to the one or more projections of the forearm housing and a distal end opposite to the proximal end. The one or more flexible connector loop is connected to the distal end of the one or more biasing element and extends through the distal opening of the forearm housing, the one or more axially extending passages of the carpal attachment, the metacarpal channel, the phalangeal cavity, the two laterally extending proximal cavities, and the through hole. The one or more biasing element and the one or more flexible connector loop cooperatively bias the terminal surface of the one or more middle phalanx portion against the dislocation guide surface of the one or more proximal phalanx portion.

In one or more embodiments, a method is provided for fabricating a finger joint reduction simulation training device. The method includes providing a forearm housing having a proximal end, a distal end with a distal opening, an access opening located between the proximal end and the distal end, and an inner cavity that is in fluid communication with the access opening and the distal opening; and securing a carpal attachment to the distal end of the forearm housing. The carpal attachment has one or more axially extending passages that are in fluid communication with the distal opening of the forearm housing. The method further includes pivotally attaching one or more metacarpal portion to the carpal attachment. The one or more metacarpal portion has an axially extending metacarpal channel. The method further includes pivotally attaching one or more proximal phalanx portion to the one or more metacarpal portion. The one or more proximal phalanx portion has an axially extending phalangeal cavity and two laterally extending cavities in fluid communication with the phalangeal cavity. The method further includes positioning one or more middle phalanx portion next to the one or more proximal phalanx portion with the one or more middle phalanx portion having a through hole; securing one or more biasing element in the inner cavity of the forearm housing; inserting a connector loop through the through hole of the one or more middle phalanx portion, the two laterally extending cavities of the one or more proximal phalanx portion, the phalangeal cavity of the one or more proximal phalanx portion, the metacarpal channel, the one or more passage of the carpal attachment, and the distal opening of the forearm housing; and connecting the connector loop to the one or more biasing element.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a perspective view of a finger joint reduction simulation training device constructed according to an embodiment of the present invention;

FIG. 2 is a perspective view of the finger joint reduction simulation training device of FIG. 1 with a synthetic skin layer thereof removed;

FIG. 3 is an exploded view of the finger joint reduction simulation training device of FIG. 2;

FIG. 4 is a perspective view of a forearm housing of the finger joint reduction simulation training device of FIG. 2;

FIG. 5 is a sectional view of the forearm housing of FIG. 4 along lines 5-5;

FIG. 6 is a rear view of the forearm housing of FIG. 4 depicting a proximal opening thereof;

FIG. 7 is a perspective view of a carpal attachment of the finger joint reduction simulation training device of FIG. 2;

FIG. 8 is a perspective view of the carpal attachment of FIG. 7 with the body thereof being transparent to highlight various features;

FIG. 9 is a front view of the carpal attachment of FIG. 7 depicting a distal surface thereof;

FIG. 10 is a rear view of the carpal attachment of FIG. 7 depicting a proximal surface thereof;

FIG. 11 is a perspective view of a hand assembly of the finger joint reduction simulation training device of FIG. 1 attached to the carpal attachment;

FIG. 12 is a perspective view of the hand assembly of FIG. 11 with bodies of components being transparent to show internal features;

FIG. 13 is a perspective view of an exemplary metacarpal phalanx portion of the finger joint reduction simulation training device of FIG. 1;

FIG. 14 is a perspective view of the metacarpal phalanx portion of FIG. 13 with its body being transparent to depict internal components;

FIG. 15 is a perspective view of an exemplary proximal phalanx portion of the finger joint reduction simulation training device of FIG. 1;

FIG. 16 is a perspective view of the proximal phalanx portion of FIG. 15 with its body being transparent to depict internal components;

FIG. 17 is a rear perspective view of exemplary middle and distal phalanx portions of the finger joint reduction simulation training device of FIG. 1;

FIG. 18 is a side view of the middle and distal phalanx portions of FIG. 17;

FIG. 19 is a perspective view of an exemplary proximal phalanx portion of the finger joint reduction simulation training device of FIG. 1 configured to simulate lateral dislocation and reduction;

FIG. 20 is a perspective view of the proximal phalanx portion of FIG. 19 with its body being transparent to depict internal components;

FIG. 21 is a rear perspective view of exemplary middle and distal phalanx portions corresponding to the proximal phalanx portion of FIG. 19;

FIG. 22 is a top plan view of the middle and distal phalanx portions of FIG. 21;

FIG. 23 depicts a flowchart of substeps of a method according to an embodiment of the present invention for assembling a finger joint reduction simulation training device; and

FIG. 24 depicts a flowchart of substeps of a method according to an embodiment of the present invention for using a finger joint reduction simulation training device.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

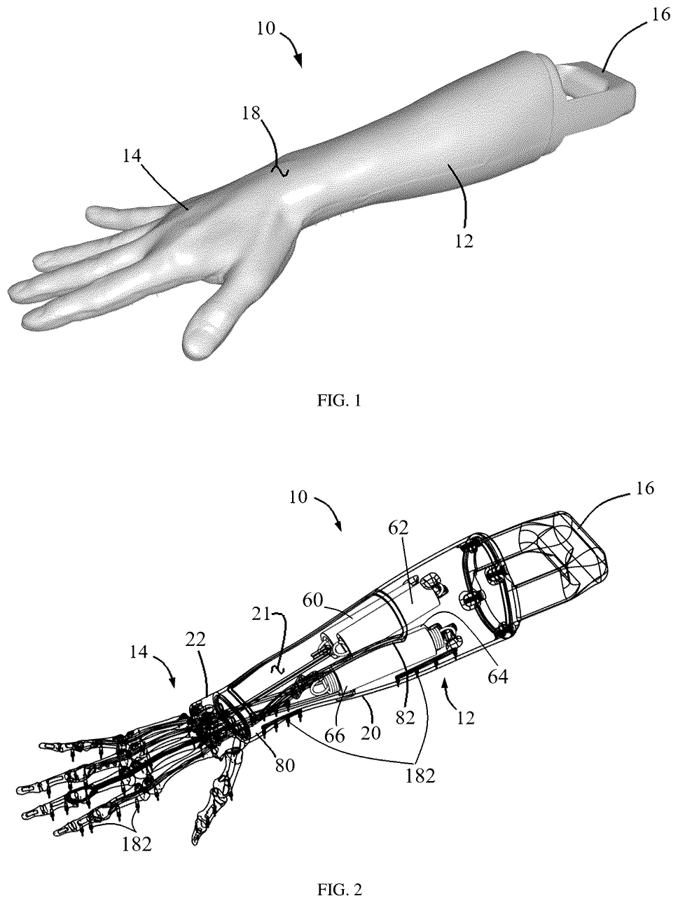

Referring to FIG. 1, an embodiment of a finger joint reduction simulation training device 10 is depicted. The device 10 includes a forearm portion 12, a hand portion 14, a handle 16, and an outer layer of synthetic skin 18. The handle 16 is secured to the forearm portion 12 and provides a secure grip for holding the device 10 during use. However, any number of attachments may be secured to the device 10 instead of the handle. For example, the device 10 may secured to another object that anchors the device instead of the handle 16 attachment. The synthetic skin 18 may be cured over the internal components of the device 10 (discussed in more detail below) in a mold or the like, and may comprise silicone rubber, such as platinum cure or Dragon Skin™ addition cure silicone, or the like.

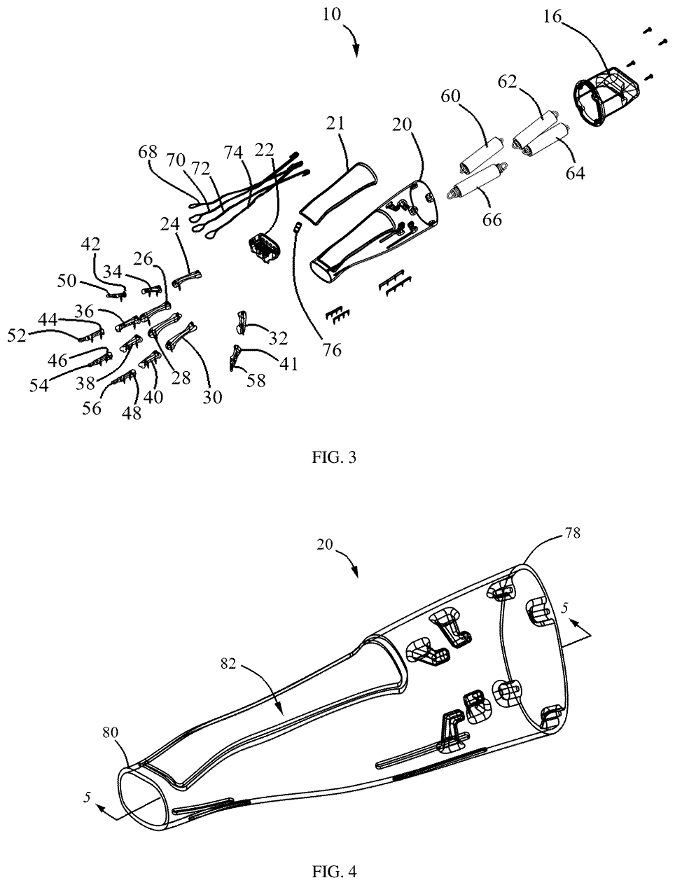

Turning to FIG. 2, the device 10 is depicted with the synthetic skin 18 removed. In one or more embodiments, the synthetic skin 18 is configured to be rolled up towards the hand for accessing certain components of the device 10. Turning to FIG. 3, the device 10 includes a forearm housing 20, a removable lid 21, a carpal attachment 22, one or more metacarpal portions 24, 26, 28, 30, 32, one or more proximal phalanx portions 34, 36, 38, 40, 41, one or more middle phalanx portions 42, 44, 46, 48, one or more distal phalanx portions 50, 52, 54, 56, 58, one or more biasing elements 60, 62, 64, 66, one or more flexible connector loops 68, 70, 72, 74, and a tension adjustment mechanism 76.

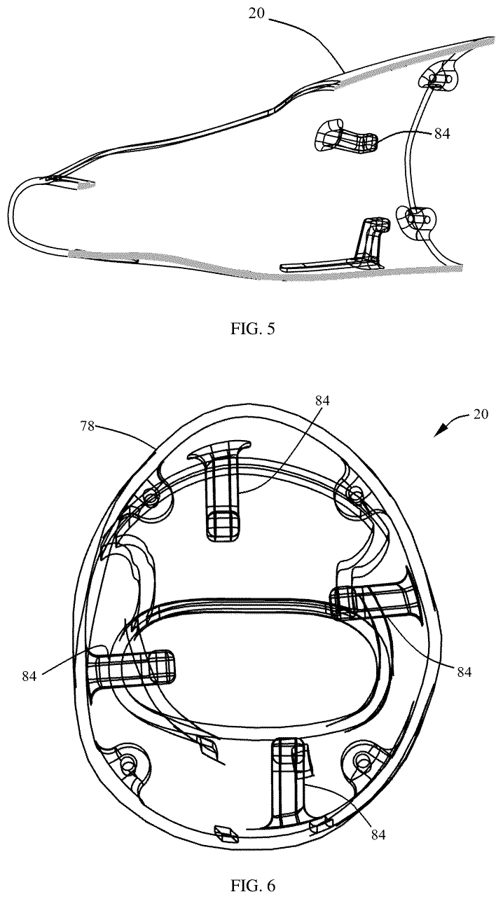

Turning to FIG. 4 in which the forearm housing 20 is depicted with transparent outer walls, the forearm housing 20 defines an inner cavity with an inner surface and includes a proximal end 78, a distal end 80, and an access opening 82. The proximal end 78 has a proximal opening, the distal end 80 has a distal opening, and the access opening 82 is located between the proximal end 78 and the distal end 80 and is in communication with the inner cavity. As depicted in FIG. 5, the forearm housing 20 also includes one or more projections 84 for engaging the one or more biasing elements. As depicted in FIG. 6, the one or more projections 84 extend radially inward from the inner surface of the inner cavity. Turning briefly back to FIG. 2, the handle 16 is attached to the proximal end 78 of the forearm housing 20. The lid 21 is removably secured to the access opening 82. The carpal attachment 22 is connected to the distal end 80 of the forearm housing 20.

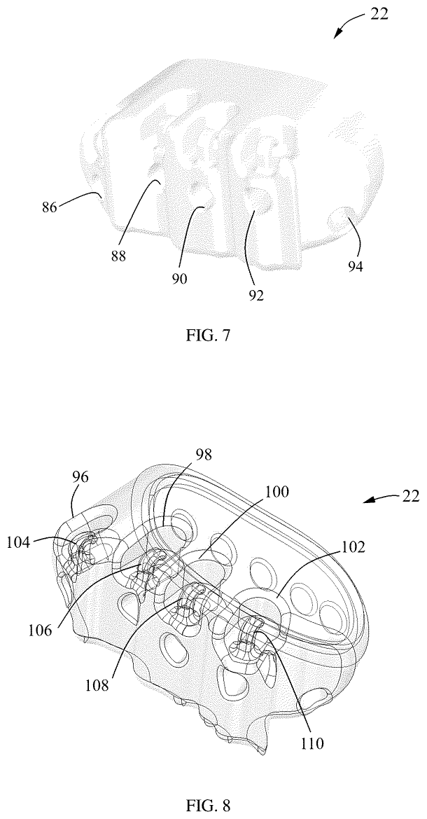

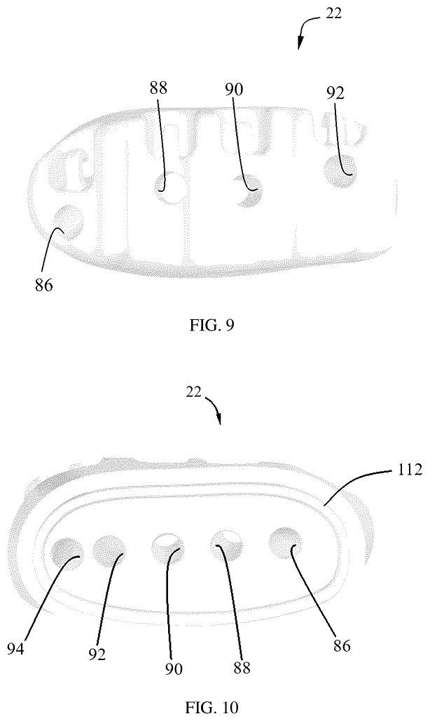

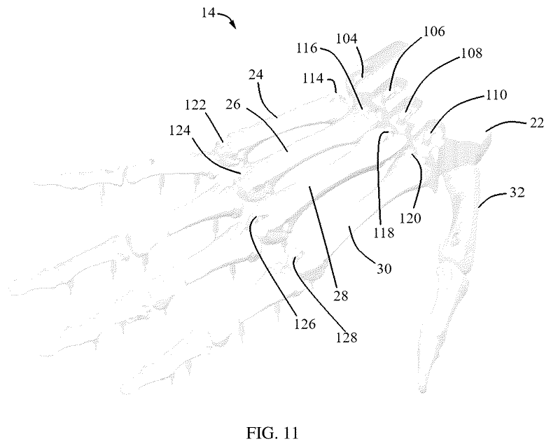

Turning to FIG. 7, the carpal attachment 22 has one or more generally axially extending passages 86, 88, 90, 92, 94 that are in fluid communication with the inner cavity of the forearm housing when attached thereto. As best seen in FIG. 8, the carpal attachment 22 includes recesses 96, 98, 100, 102 from which attachment structures 104, 106, 108, 110 extend. The attachment structures 104, 106, 108, 110 may include hook-shaped projections for securing the metacarpal portions 24, 26, 28, 30. Turning to FIG. 9, the passages 86, 88, 90, 92, 94 extend from the distal surface into the body of the carpal attachment 22. One or more of the passages 86, 88, 90, 92, 94 extend into the face of the distal end at angles relative to a proximal-to-distal axis through the length of the carpal attachment 22 so that opposing ends of the passages 86, 88, 90, 92, 94 are located within a protruding lip 112, as depicted in FIG. 10. The lip 112 is configured to engage an inner surface of the distal opening of the forearm housing to secure the carpal attachment 22 to the forearm housing.

Turning to FIG. 11, the metacarpal portions 24, 26, 28, 30, 32 are pivotally connected to the carpal attachment 22. In one or more embodiments, one or more of the metacarpal portions 24, 26, 28, 30 include attachment structures 114, 116, 118, 120 corresponding to the attachment structures 104, 106, 108, 110 of the carpal attachment 22. The attachment structures 114, 116, 118, 120 may be located on proximal ends of the metacarpal portions 24, 26, 28, 30 and include projections having through holes for receiving cabling, such as metal cables, wires, cords, or the like. In one or more embodiments, the cabling is nylon kernmantle rope, such as paracord. Connections that allow pivotal movement between the metacarpal portions 24, 26, 28, 30 and the carpal attachment 22 but that limits relative displacement in axial (proximal to distal or vice versa) directions is more realistic, especially when simulating dislocations and reductions of proximal and/or distal interphalangeal joints. In one or more embodiments, one or more of the metacarpal portions 24, 26, 28, 30 also include attachment structures 122, 124, 126, 128 on distal ends thereof.

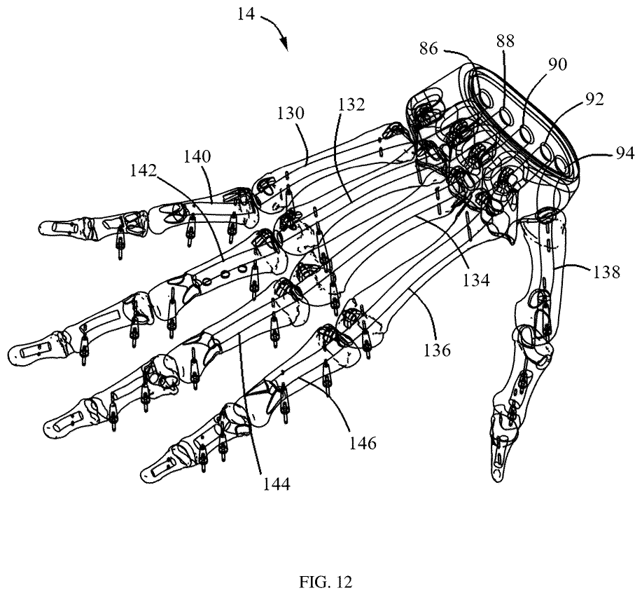

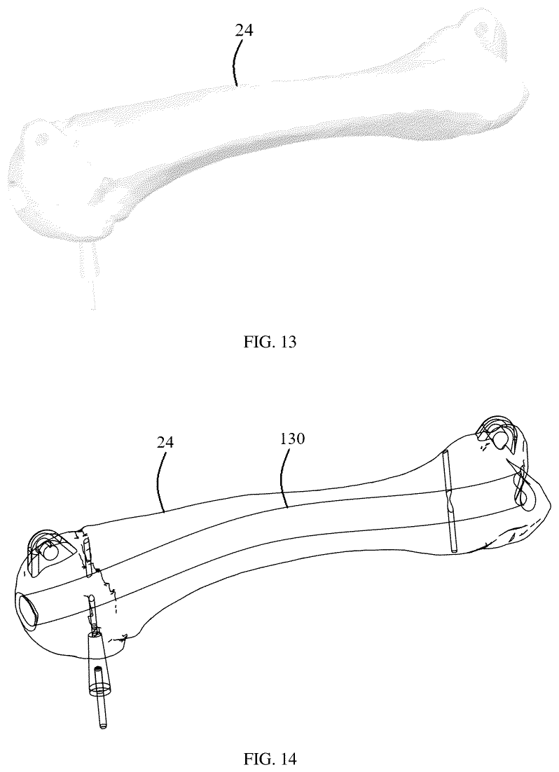

As depicted in FIG. 12, the metacarpal portions include axially extending metacarpal channels 130, 132, 134, 136, 138 that are at least partially aligned with the passages 86, 88, 90, 92, 94 of the carpal attachment. In one or more embodiments, the metacarpal channels 130, 132, 134, 136 are also aligned with cavities 140, 142, 144, 146 of the proximal phalanx portions. As discussed in further detail, the flexible connector loops are inserted through these passages and cavities. Turning to FIG. 13, an exemplary metacarpal portion 24 is depicted. The metacarpal portion 24 is shaped to mimic a metacarpal bone of a human hand. As shown in FIG. 14, the channel 130 extends the axial length of the metacarpal portion 24.

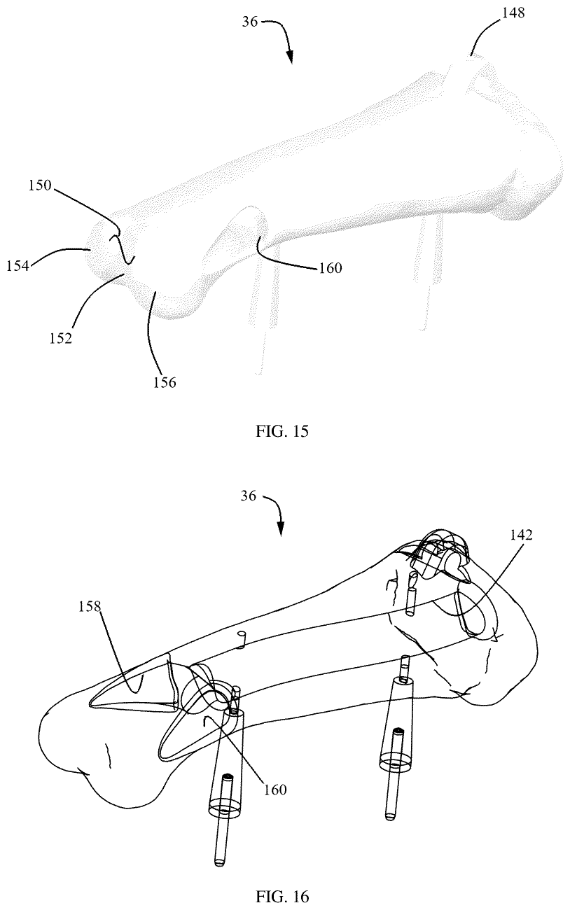

Turning to FIG. 15, an exemplary proximal phalanx portion 36 is depicted. One or more of the other proximal phalanx portions may have substantially similar features. The proximal phalanx portion 36 is configured to be pivotally connected to the corresponding metacarpal portion 26 and includes a proximal end with an attachment structure 148 corresponding to the attachment structure 126 of the metacarpal portion 26 and a distal end. The distal end includes a dislocation guide surface 150 with a depression 152 corresponding to an intercondylar groove formed thereon. The intercondylar groove, or depression 152, may be defined by two or more ridges 154, 156 sized to mimic condyles of a proximal phalanx head with articular cartilage. In one or more embodiments, the depression 152 is a groove extending in a dorsal-palmar direction to simulate dorsal/palmar dislocations and reductions.

Turning to FIG. 16, the proximal phalanx portion 36 includes two laterally extending proximal cavities 158, 160 that are in fluid communication with the phalangeal cavity 142. The two laterally extending proximal cavities 158, 160 are formed in opposing lateral sides of the proximal phalanx portion 36. In one or more embodiments, the proximal cavities 158, 160 extend in directions that are oblique relative to the longitudinal axis of the proximal phalanx portion 36 from the cavity 142 of the proximal phalanx portion 36 in a distal direction. In one or more embodiments, the edges of the openings of the proximal cavities 158, 160 are chamfered (best shown in FIG. 15) to avoid wear on the proximal phalanx portion 36 and/or the corresponding connector loop.

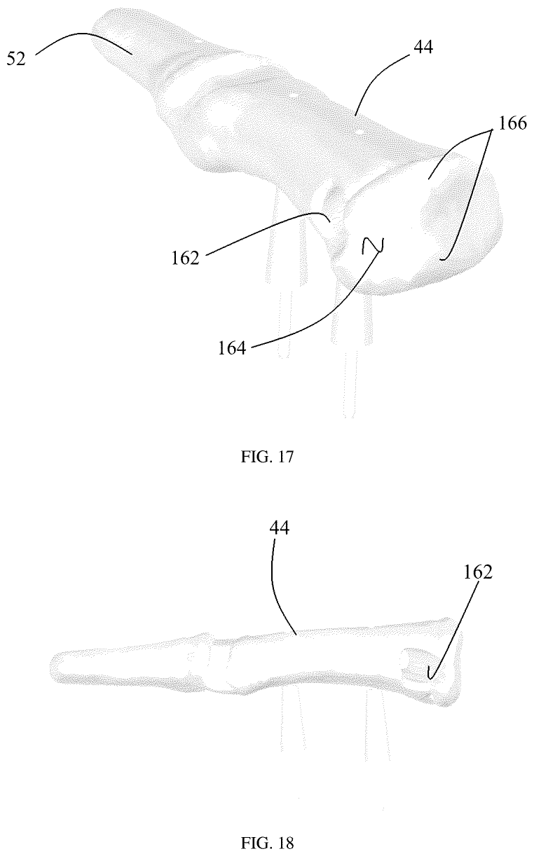

Turning to FIG. 17, exemplary middle and distal phalanx portions 44, 52 are depicted. In one or more embodiments, the middle and distal phalanx portions 44, 52 are connected as a solid, unitary piece. However, the middle and distal phalanx portions may be joined any number of ways without departing from the scope of the present invention, including via a pivotal connection. The middle phalanx portion 44 has a proximal end with a through hole 162 formed therein. The proximal end includes a terminal surface 164 configured to shift relative to the dislocation guide surface 150 of the proximal phalanx portion 36 and has one or more projections 166 configured to extend into the depression of the dislocation guide surface. The dislocation guide surface guides the projection 166 back into place during a simulated reduction. Contact between the projection 166 and the guide surface-aided by the corresponding biasing element-produces a sound and feel that accurately reflects a real joint reduction.

Turning to FIG. 18, the through hole 162 extends laterally through the proximal end of the middle phalanx portion 44. The through hole 162 comprises two cavities extending obliquely from a longitudinal axis of the middle phalanx portion 44 in a proximal direction. The edges of the through hole 162 on the exterior surface of the middle phalanx portion 44 are chamfered to inhibit wear on the middle phalanx portion 44 and/or the corresponding connector loop. The corresponding connector loop extends through the through hole 162 of the middle phalanx portion 44 and the cavities of the proximal phalanx portion to cooperatively form a pair of laterally extending axes of rotation in the through hole and cavities so that the middle phalanx portion 44 can be positioned in palmar and dorsal dislocation positions.

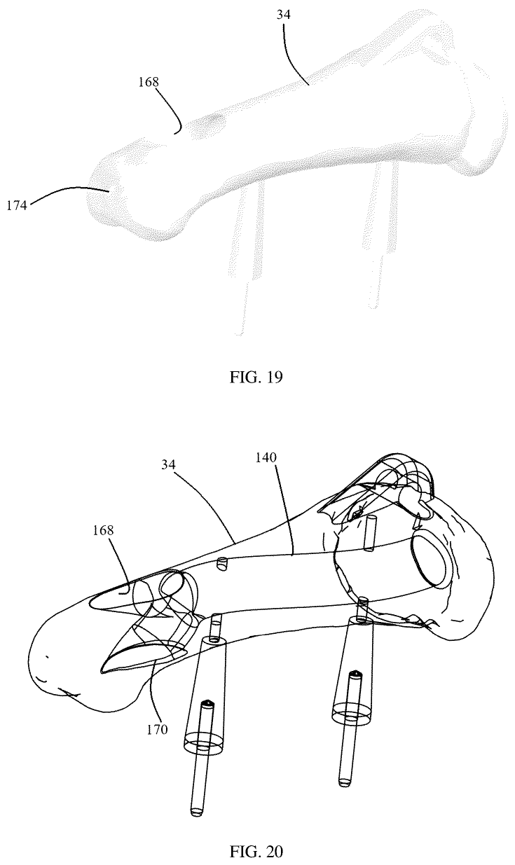

Turning to FIGS. 19-22, one or more of the proximal and middle phalanx portions 34, 42 include cavities 168, 170 and a through hole 172 that extend in palmar/dorsal directions to enable simulation of lateral dislocations and reductions. As shown in FIG. 19, the distal surface of the proximal phalanx portion 34 includes a projection 174 extending from an inter-condylar groove that guides the middle phalanx portion 42 to shift laterally when simulating a lateral dislocation. Turning to FIG. 20, the proximal phalanx portion 34 includes cavities 168, 170 in fluid communication with the proximal phalanx portion axially extending cavity 140. The cavities 168, 170 may extend obliquely from the cavity 140.

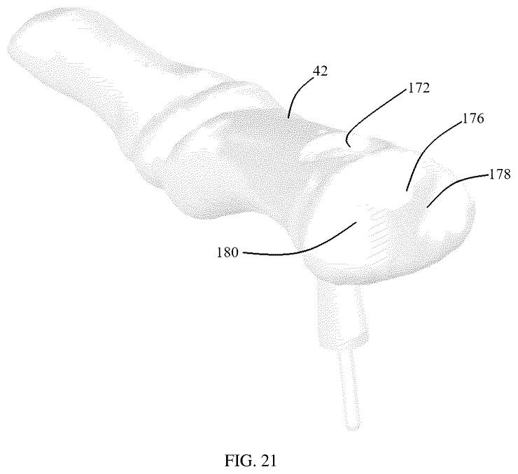

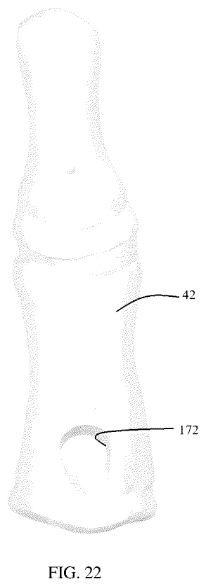

Turning to FIG. 21, middle phalanx portion 42 includes the corresponding through hole 172 having a proximal end surface with a projection 176 that abuts the projection 174 of the middle phalanx portion 42. The proximal end surface also includes two outwardly extending depressions 178, 180 for guiding the projection 174 for lateral dislocations and reductions. Turning to FIG. 22, the edges of the through hole 172 are chamfered to help avoid wear on the corresponding connector loop. The edges of the through hole 172 on the portions of the surfaces closest to the proximal end of the middle phalanx portion 42 are the most beveled because the connect loop will contact those portions. While the second through fourth digits of the device 10 are configured for palmar and/or dorsal dislocation/reduction with the fifth digit (pinky finger) being configured for lateral dislocation/reduction, the digits may be configured for any type of dislocation/reduction without departing from the scope of the present invention. Additionally, one or more of the digits may be configured for both types of dislocations/reductions.

Turning back to FIG. 2, the one or more biasing elements 60, 62, 64, 66 are configured to provide biofidelic forces of muscles and tendons when simulating dislocation and reduction. The biasing elements 60, 62, 64, 66 are positioned in the forearm housing 20 and have proximal ends connected to the one or more projections of the forearm housing 20 and distal ends opposite to the proximal end. As depicted, in one or more embodiments, the biasing elements 60, 62, 64, 66 comprise springs with sound dampening materials wrapped around the springs. The sound dampening materials reduce the sound of the springs (or other biasing element) to produce a sound that is more accurate when simulating reduction. In one or more embodiments, the sound dampening materials comprise silicone tubes.

Turning to FIG. 3, the one or more flexible connector loops 68, 70, 72, 74 are connected to the distal end of the biasing elements 60, 62, 64, 66 and extend through the distal openings of the forearm housing 20, the axially extending passages of the carpal attachment 22, the metacarpal channels (depicted in FIG. 12), the phalangeal cavities and the laterally extending cavities of the proximal phalanx portions (also in FIG. 12), and the through holes of the middle phalanx portions. The biasing elements and the connector loops cooperatively bias the middle phalanx portions against the proximal phalanx portions. The connector loops 68, 70, 72, 74 may comprise cabling, such as metal cables, wires, cords, or the like. In one or more embodiments, the connector loops 68, 70, 72, 74 are nylon kernmantle rope, such as paracord.

The one or more tension adjustment mechanisms 76 is configured to increase and/or decrease the biasing force applied to one or more of the digits. The tension adjustment mechanisms 76 may be accessible through the access opening in the forearm housing 20 by removing the lid 21. The one or more tension adjustment mechanisms 76 may be attached to one or more of the connector loops 68, 70, 72, 74 for increasing or decreasing lengths of the connector loops 68, 70, 72, 74. In one or more embodiments, the tension adjustment mechanism 76 comprises a cord lock or cord stop.

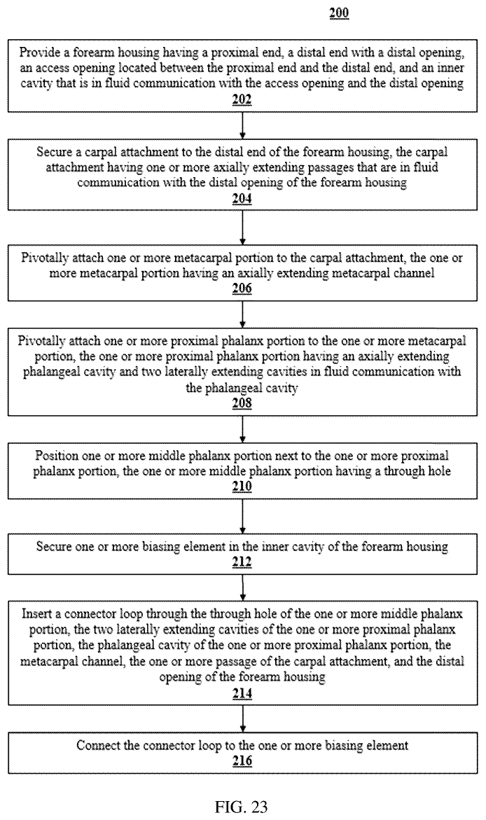

Referring to FIG. 23, an embodiment of a method 200 is shown for fabricating a finger joint reduction simulation training device. Although FIG. 23 shows example steps of the method 200, in some implementations, the method 200 may include additional steps, fewer steps, different steps, or differently arranged steps than those depicted in FIG. 23. Additionally, or alternatively, two or more of the steps of method 200 may be performed in parallel.

Referring to step 202, the method 200 includes providing the forearm housing 20. The forearm housing may be provided by forming it molding, additive manufacturing, or the like. The forearm housing may be sized and shaped to accurately mimic a patient's forearm. In one or more embodiments, the forearm housing may be sized and shaped to mimic the forearm of a patient of a particular demographic, i.e., age, sex, height/weight, etc. In one or more embodiments, the forearm housing is formed with stand-offs 182 (depicted in FIG. 2). As described in more detail below, the stand-offs 182 provide a buffer between the forearm housing and a mold for forming the synthetic skin around the forearm housing.

Referring to step 204, the carpal attachment 22 is secured to the distal end of the forearm housing. This step may include forming the carpal attachment via molding, additive manufacturing, or the like. In one or more embodiments, the lip 112 of the carpal attachment 22 is inserted into the distal opening of the forearm housing. The carpal attachment may be removably attached to the forearm housing. In one or more embodiments, the carpal attachment is bonded to the forearm housing by applying adhesive to the lip of the carpal attachment and or the inner surface of the distal opening of the forearm housing.

Referring to step 206, one or more of the metacarpal portions 24, 26, 28, 30, 32 arc attached to the carpal attachment. This step may include forming the metacarpal portions via molding, additive manufacturing, or the like. In one or more embodiments, the metacarpal portions are formed based on a scan of a patient. The metacarpal portions may also have stand-offs formed thereon. In one or more embodiments, the metacarpal portions are pivotally attached by tying cords around the attachment structures 104, 106, 108, 110 of the carpal attachment and the attachment structures 114, 116, 118, 120 of the metacarpal portions. The metacarpal portions may be attached to the carpal attachment so that the metacarpal channels are aligned with the passages of the carpal attachment.

Referring to step 208, one or more proximal phalanx portions 34, 36, 38, 40, 41 are attached to the one or more metacarpal portions. This step may include forming the proximal phalanx portions via molding, additive manufacturing, or the like. In one or more embodiments, the proximal phalanx portions are formed based on a scan of a patient. The proximal phalanx portions may also have stand-offs formed thereon. The proximal phalanx portions may be pivotally attached via cords tied around the attachment structures of the metacarpal portions and the corresponding attachment structures of the proximal phalanx portions. The proximal phalanx portions may be attached so that their axially extending phalangeal cavities are generally aligned with the corresponding metacarpal channels.

Referring to step 210, the one or more middle phalanx portions 42, 44, 46, 48 are positioned adjacent to the one or more proximal phalanx portions. This step may include forming the middle phalanx portions via molding, additive manufacturing, or the like. In one or more embodiments, the middle phalanx portions are formed based on a scan of a patient. The middle phalanx portions may also have stand-offs formed thereon. In one or more embodiments, the middle phalanx portions are formed as unitary pieces with corresponding distal phalanx portions 50, 52, 54, 56, 58.

Referring to step 212, one or more of the biasing elements 60, 62, 64, 66 are secured in the inner cavity of the forearm housing. This step may include inserting the biasing elements into the proximal opening of the forearm housing. In one or more embodiments, the dampening material is positioned around the springs of the biasing elements, and the distal ends of the springs are hooked onto the projections 84 in the forearm housing.

Referring to step 214, one or more of the connector loops 68, 70, 72, 74 are inserted through the through hole of the middle phalanx portions, the two laterally extending cavities of the proximal phalanx portions, the phalangeal cavity of the one or more proximal phalanx portions, the metacarpal channel, the one or more passages of the carpal attachment, and the distal opening of the forearm housing.

Referring to step 216, one or more of the connector loops are secured to the one or more biasing elements. For example, the connector loops may be tied to the one or more biasing elements.

The method 200 may include additional implementations, such as any single implementation or any combination of implementations described below and/or in connection with one or more other processes described elsewhere herein. A first implementation method 200 may include forming the one or more metacarpal portions, the one or more proximal phalanx portions, and the one or more middle phalanx portions based on three-dimensional files derived from scans of a human hand. In a second implementation, alone or in combination with the first implementation, the one or more metacarpal portions, the one or more proximal phalanx portions, and the one or more middle phalanx portions are formed via additive manufacturing. A third implementation, alone or in combination with the first and second implementations, method 200 may include drilling the one or more axially extending passages in the carpal attachment. A fourth implementation, alone or in combination with one or more of the first through third implementations, method 200 further includes drilling the axially extending metacarpal channel in the one or more metacarpal portions, drilling the one or more phalangeal cavities in the one or more proximal phalanx portions, drilling the two laterally extending proximal cavities in the one or more proximal phalanx portions, and drilling the through hole in the one or more middle phalanx portions.

A fifth implementation, alone or in combination with one or more of the first through fourth implementations, method 200 may include chamfering one or more exterior surface edges around at least one of the two laterally extending proximal cavities in the one or more proximal phalanx portions or the through hole in the one or more middle phalanx portions.

A sixth implementation, alone or in combination with one or more of the first through fifth implementations, method 200 further includes forming offsets on at least one of the forearm housing, the carpal attachment, the one or more metacarpal portions, the one or more proximal phalanx portions, or the one or more middle phalanx portions, positioning the forearm housing, the carpal attachment, the one or more metacarpal portions, the one or more proximal phalanx portions, and the one or more middle phalanx portions in a mold corresponding to at least a portion of a human hand, and injecting liquefied synthetic skin into the mold. A seventh implementation, alone or in combination with one or more of the first through sixth implementations, method 200 may include curing the synthetic skin and removing the offsets.

An eighth implementation, alone or in combination with one or more of the first through seventh implementations, method 200 may include positioning a tension adjustment mechanism in operative association with the one or more biasing elements or the connector loop and adjusting one or more biasing forces of the one or more biasing elements via the tension adjustment mechanism.

A ninth implementation, alone or in combination with one or more of the first through eighth implementations, method 200 may include securing the handle to the proximal end of the forearm housing.

The method 200 may include more, fewer, or alternative actions, including those discussed elsewhere herein.

Any actions, functions, steps, and the like recited herein may be performed in the order shown in the figures and/or described above, or may be performed in a different order. Furthermore, some steps may be performed concurrently as opposed to sequentially.

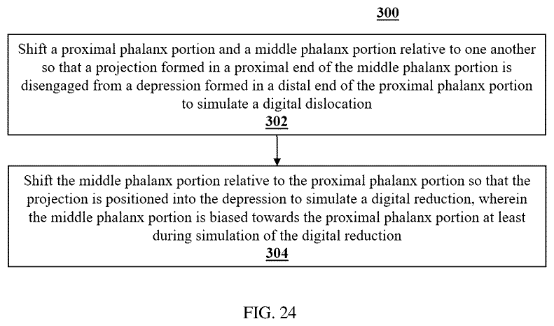

Referring to FIG. 24, an embodiment of a method 300 is shown for using a finger joint reduction simulation training device. Although FIG. 24 shows example steps of the method 300, in some implementations, the method 300 may include additional steps, fewer steps, different steps, or differently arranged steps than those depicted in FIG. 24. Additionally, or alternatively, two or more of the steps of method 300 may be performed in parallel. The method may be performed using the elements depicted in FIGS. 1-22.

Referring to step 302, one or more of the proximal phalanx portions 34, 36, 38, 40 and one or more of the middle phalanx portions 42, 44, 46, 48 are shifted relative to one another to simulate one or more digital dislocation. The phalanx portions may be shifted any number of directions without departing from the scope of the present invention to simulate any type of dislocation. For example, the proximal phalanx portion 36 and the corresponding middle phalanx portion 44 may be shifted relative to one another to simulate a dorsal or palmar dislocation, and the proximal phalanx portion 34 and the corresponding middle phalanx portion 42 may be shifted to simulate a lateral dislocation. The respective phalanx portions may be shifted until their respective projections 166, 176 disengage from corresponding depressions 152, 174.

Referring to step 304, the proximal phalanx portions 34, 36, 38, 40 are shifted relative to corresponding middle phalanx portions 42, 44, 46, 48 to simulate one or more digital reduction. The phalanx portions may be shifted any number of directions without departing from the scope of the present invention to simulate the appropriate type of reduction based on the simulated dislocation positions of the phalanx portions. For example, the proximal phalanx portion 36 and the corresponding middle phalanx portion 44 may be shifted relative to one another to simulate a dorsal or palmar dislocation reduction, and the proximal phalanx portion 34 and the corresponding middle phalanx portion 42 may be shifted to simulate a lateral dislocation reduction. The respective phalanx portions may be shifted until their respective projections 166, 176 reengage with corresponding depressions 152, 174.

As discussed above, the proximal phalanx portions 34, 36, 38, 40 and corresponding middle phalanx portions 42, 44, 46, 48 may be biased toward one another via the connector loops 68, 70, 72, 74 and biasing elements 60, 62, 64, 66.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A finger joint reduction simulation training device comprising:
a proximal phalanx portion comprising a proximal end and a distal end opposite the proximal end and comprising a dislocation guide surface with a depression formed therein; and
a middle phalanx portion resiliently associated with the proximal phalanx portion and comprising a proximal end with a terminal surface configured to shift relative to the dislocation guide surface and having a projection configured to extend into the depression of the dislocation guide surface.

2. The finger joint reduction simulation training device of claim 1, wherein the proximal end of the middle phalanx portion has a through hole extending transverse to a longitudinal axis of the middle phalanx portion for receiving an elongate member for coupling the proximal phalanx portion and the middle phalanx portion.

3. The finger joint reduction simulation training device of claim 2, wherein the through hole extends laterally through the proximal end.

4. The finger joint reduction simulation training device of claim 2, wherein the through hole extends in a palmar to dorsal direction through the proximal end.

5. The finger joint reduction simulation training device of claim 2, wherein the distal end of the proximal phalanx portion has two cavities in fluid communication with a central channel for receiving a portion of the elongate member.

6. The finger joint reduction simulation training device of claim 5, wherein the two cavities of the proximal phalanx portion extend obliquely relative to a longitudinal axis of the proximal phalanx portion from the central channel of the proximal phalanx portion and in a distal direction.

7. The finger joint reduction simulation training device of claim 1, further comprising a distal phalanx portion connected to the middle phalanx portion.

8. The finger joint reduction simulation training device of claim 7, wherein the distal phalanx portion and the middle phalanx portion are fixed relative to one another.

9. The finger joint reduction simulation training device of claim 1, wherein the depression forming the dislocation guide surface is defined by one or more ridges sized to mimic a proximal phalanx head with articular cartilage.

10. The finger joint reduction simulation training device of claim 1, wherein the depression forming the dislocation guide surface is a groove extending in a dorsal to palmar direction.

11. The finger joint reduction simulation training device of claim 1, wherein the depression forming the dislocation guide surface is a groove extending in a lateral direction.

12. A finger joint reduction simulation training device comprising:
a forearm portion having a distal end;
a carpal attachment connected to the distal end of the forearm portion;
a metacarpal portion connected to the carpal attachment;
a proximal phalanx portion comprising a proximal end connected to the metacarpal portion and a distal end opposite the proximal end and comprising a dislocation guide surface with a depression formed therein;
a middle phalanx portion positioned adjacent the proximal phalanx portion and comprising a proximal end with a terminal surface configured to shift relative to the dislocation guide surface and having a projection configured to extend into the depression of the dislocation guide surface; and
at least one biasing element configured to bias the terminal surface of the middle phalanx portion against the dislocation guide surface.

13. The finger joint reduction simulation training device of claim 12, wherein the forearm portion defines an inner cavity, and the biasing element is positioned in the inner cavity of the forearm portion.

14. The finger joint reduction simulation training device of claim 13, further comprising a flexible connector operatively associated with the biasing element and the middle phalanx portion.

15. The finger joint reduction simulation training device of claim 14, wherein:
the distal end of the forearm portion includes a passage in fluid communication with the inner cavity,
the carpal attachment, the metacarpal portion, and the proximal phalanx portion define channels, and
the flexible connector is connected to the biasing element in the inner cavity and extends through the passage and the channels and is operatively associated with the middle phalanx portion.

16. The finger joint reduction simulation training device of claim 12, further comprising a tension adjustment mechanism configured to adjust a biasing force of the biasing element.

17. The finger joint reduction simulation training device of claim 12, wherein the depression forming the dislocation guide surface is a groove extending in a dorsal to palmar direction.

18. The finger joint reduction simulation training device of claim 17, further comprising:
a second metacarpal portion connected to the carpal attachment;
a second proximal phalanx portion comprising a proximal end connected to the second metacarpal portion and a distal end opposite the proximal end and comprising a dislocation guide surface with a depression formed therein; and
a second middle phalanx portion positioned adjacent the second proximal phalanx portion and comprising a proximal end with a terminal surface configured to shift relative to the dislocation guide surface of the second proximal phalanx portion and having a projection configured to extend into the depression of the dislocation guide surface of the second proximal phalanx portion,
wherein the at least one biasing element is configured to bias the terminal surface of the second middle phalanx portion against the dislocation guide surface of the second proximal phalanx portion, and
wherein the depression forming the dislocation guide surface of the second proximal phalanx portion is a groove extending in a lateral direction.

19. A method of fabricating a finger joint reduction simulation training device, the method comprising:
providing a forearm housing having a proximal end, a distal end with a distal opening, an access opening located between the proximal end and the distal end, and an inner cavity that is in fluid communication with the access opening and the distal opening;
securing a carpal attachment to the distal end of the forearm housing, the carpal attachment having one or more axially extending passages that are in fluid communication with the distal opening of the forearm housing;
pivotally attaching at least one metacarpal portion to the carpal attachment, the at least one metacarpal portion having an axially extending metacarpal channel;
pivotally attaching at least one proximal phalanx portion to the at least one metacarpal portion, the at least one proximal phalanx portion having an axially extending phalangeal cavity and two laterally extending cavities in fluid communication with the phalangeal cavity;
positioning at least one middle phalanx portion adjacent to the at least one proximal phalanx portion, the at least one middle phalanx portion having a through hole;
securing at least one biasing element in the inner cavity of the forearm housing;
inserting a connector loop through the through hole of the at least one middle phalanx portion, the two laterally extending cavities of the at least one proximal phalanx portion, the phalangeal cavity of the at least one proximal phalanx portion, the metacarpal channel, the one or more passages of the carpal attachment, and the distal opening of the forearm housing; and
connecting the connector loop to the biasing element.

20. The method of claim 19, further comprising forming the at least one metacarpal portion, the at least one proximal phalanx portion, and the at least one middle phalanx portion based on three-dimensional files derived from scans of a human hand.
